(19) United States
(12) Patent Application Publication
(10) Pub. No.: US 2017/0115748 A1
(43) Pub. Date: Apr. 27, 2017

(54) PROGRAM, SYSTEM AND METHOD

(71) Applicant: KABUSHIKI KAISHA SQUARE ENIX (also trading as SQUARE ENIX CO., LTD.), Tokyo (JP)

(72) Inventor: Kei ODAGIRI, Tokyo (JP)

(73) Assignee: KABUSHIKI KAISHA SQUARE ENIX (also trading as SQUARE ENIX CO., LTD.), Tokyo (JP)

(21) Appl. No.: 15/297,513

(22) Filed: Oct. 19, 2016

(30) Foreign Application Priority Data
Oct. 23, 2015 (JP) 2015-208839

(51) Int. Cl. G06F 3/0338; A63F 13/35; A63F 13/24; G06F 3/038; A63F 13/25

(52) U.S. Cl. CPC G06F 3/0338; G06F 3/038; A63F 13/25; A63F 13/24; A63F 13/35

(57) ABSTRACT

A non-transitory computer-readable medium including a program product for causing a computer to realize functions to carry out various kinds of processing on the basis of an operational input via an operation key or a stick provided in a controller is provided. The functions include: a receiving function configured to receive a predetermined operational input (first input) and an operational input different from the first input (second input) of operational inputs; an updating function configured to update a coordinate indicating one point in a two-dimensional system on the basis of the first input (first coordinate), the updating function being configured to update a coordinate different from the first coordinate (second coordinate) on the basis of the second input; and a displaying function configured to display, on a display screen of a display device, at least one of an image corresponding to the first coordinate (first image) and an image corresponding to the second coordinate (second image).

### CROSS-REFERENCE TO RELATED APPLICATION

The present application relates to subject matter contained in Japanese Patent Application No. 2015-208839 field on Oct. 23 2015, the disclosure of which is expressly incorporated herein by reference in its entirety.

### BACKGROUND OF THE INVENTION

1. Field of the Invention

At least one of embodiments according to the present invention relates to a program, a system and a method for causing a computer to realize functions to carry out various kinds of processes on the basis of an operational input via an operation key or a stick provided in a controller.

2. Description of the Related Art

Heretofore, various kinds of systems for utilizing a pointing device as a controller by which a video game and the like are operated have been proposed.

In such a system, there is one that uses, as the pointing device, an input device provided with an imaging apparatus, for example, in addition to a mouse pointer (see Japanese Patent Application Publication No. 2011-224239).

On the other hand, even in recent years, there is a demand to carry out various kinds of operational inputs by only a controller that does not include a function as a pointing device (hereinafter, referred to simply as the “controller”). Namely, a user who feels usefulness of a system in which an arbitrary operational input can be carried out by means of only a key operation and/or a stick operation on the basis of an action of the controller itself without specifying a position on a plain exists. However, in the conventional system, as a method of specifying a position on the plain, there was an aspect that operability of the controller is thought to be worse in a case where a pointing device and a controller are compared with each other. This is because, in a case of specifying a position on a plain by means of a controller, the position has to be specified by a time to operate a key or a stick and a movement speed of the specified position. It is thought that as one cause it is difficult compared with the pointing device by which the user can directly specify a position on the plane. Namely, in the conventional system, one point provided on a display screen of a display device has to be caused to move vertically and horizontally by a press of a directional key or a tilt of a stick, which are provided on the controller. For this reason, there is the case where the user feels low operability in a case where it is compared with the pointing device.

### SUMMARY OF THE INVENTION

It is an object of at least one of embodiments according to the present invention to solve the problem described above, and to improve operability of a system in which a controller that does not have a function as a pointing device is used.

According to one non-limiting aspect of the present invent ion, there is provided a non-transitory computer-readable medium including a program product for causing a computer to realize functions to carry out various kinds of processing on the basis of an operational input via an operation key or a stick provided in a controller.

The functions include a receiving function configured to receive a predetermined operational input (hereinafter, referred to as a “first input”) and an operational input different from the first input (hereinafter, referred to as a “second input”) of operational inputs.

The functions also include an updating function configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input.

The functions also include a displaying function configured to display, on a display screen of a display device, at least one of an image corresponding to the first coordinate (hereinafter, referred to as a “first image”) and an image corresponding to the second coordinate (hereinafter, referred to as a “second image”).

According to another non-limiting aspect of the present invention, there is provided a system including a communication network, a server, and a user terminal, the user terminal carrying out various kinds of processing on the basis of an operational input via an operation key or a stick provided in a controller.

The system includes a receiving section configured to receive a predetermined operational input (hereinafter, referred to as a “first input”) and an operational input different from the first input (hereinafter, referred to as a “second input”) of operational inputs.

The system also includes an updating section configured to update a coordinate indicating one point in a two-dimensional system (hereinafter, referred to as a “first coordinate”) on the basis of the first input, the updating section being configured to update a coordinate different from the first coordinate (hereinafter, referred to as a “second coordinate”) on the basis of the second input.

The system also includes a displaying section configured to cause a display device to display, on a display screen, at least one of an image corresponding to the first coordinate (hereinafter, referred to as a “first image”) and an image corresponding to the second coordinate (hereinafter, referred to as a “second image”).

According to still another non-limiting aspect of one embodiment according to the present invention, there is provided a method of carrying out various kinds of processing on the basis of an operational input via an operation key or a stick provided in a controller.

The method includes a receiving process configured to receive a predetermined operational input (hereinafter, referred to as a “first input”) and an operational input different from the first input (hereinafter, referred to as a “second input”) of operational inputs.

The method also includes an updating process configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input.

The method also includes a displaying process configured to display, on a display screen of a display device, at least one of an image corresponding to the first coordinate (hereinafter, referred to as a “first image”) and an image corresponding to the second coordinate (hereinafter, referred to as a “second image”).

According to each of the embodiments of the present application, one or two or more shortages are solved.

### BRIEF DESCRIPTION OF THE DRAWINGS

The foregoing and other objects, features and advantages of the present invention will become more readily apparent from the following detailed description of preferred embodiments of the present invention that proceeds with reference to the appending drawings:

FIG. 1 is a block diagram showing an example of a configuration of a system corresponding to at least one of embodiments according to the present invention.

FIG. 2 is a block diagram showing a configuration of a server corresponding to at least one of the embodiments according to the present invention.

FIG. 3 is a flowchart showing an example of input/output processing corresponding to at least one of the embodiments according to the present invention.

FIG. 4 is a flowchart showing an example of an operation of a server side in the input/output processing corresponding to at least one of the embodiments according to the present invention.

FIG. 5 is flowchart showing an example of an operation of a terminal side in the input/output processing corresponding to at least one of the embodiments according to the present invention.

FIG. 6 is a block diagram showing a configuration of a user terminal corresponding to at least one of the embodiments according to the present invention.

FIG. 7 is a flowchart showing an example of the input/output processing corresponding to at least one of the embodiments according to the present invention.

FIG. 8 is a block diagram showing a configuration of the user terminal corresponding to at least one of the embodiments according to the present invention.

FIG. 9 is a flowchart showing an example of the input/output processing corresponding to at least one of the embodiments according to the present invention.

FIG. 10 is a block diagram showing a configuration of the user terminal corresponding to at least one of the embodiments according to the present invention.

FIG. 11 is a flowchart showing an example of the input/output processing corresponding to at least one of the embodiments according to the present invention.

FIG. 12 is a block diagram showing a configuration of the user terminal corresponding to at least one of the embodiments according to the present invention.

FIG. 13 is a flowchart showing an example of the input/output processing corresponding to at least one of the embodiments according to the present invention.

FIG. 14 is a block diagram showing a configuration of the user terminal corresponding to at least one of the embodiments according to the present invention.

FIG. 15 is a flowchart showing an example of processing corresponding to at least one of the embodiments according to the present invention.

FIG. 16 is a flowchart showing an example of processing corresponding to at least one of the embodiments according to the present invention.

FIG. 17 is a flowchart showing an example of processing corresponding to at least one of the embodiments according to the present invention.

FIG. 18 is an explanatory drawing for explaining an example of a game screen corresponding to at least one of the embodiments according to the present invention.

### DETAILED DESCRIPTION OF THE INVENTION

Hereinafter, examples of embodiments according to the present invention will be described with reference to the drawings. In this regard, various kinds of elements in an example of each embodiment, which will be described below, can appropriately be combined with each other in a range where contradiction or the like does not occur. Further, explanation of the content that will be described as an example of an embodiment may be omitted in another embodiment. Further, the content of operations and/or processing with no relationship to characteristic portions of each embodiment may be omitted. Moreover, various kinds of processing that constitute various kinds of processing flows (will be described below) may be carried out in random order in a range where contradiction or the like does not occur in the content of the processing.

### First Embodiment

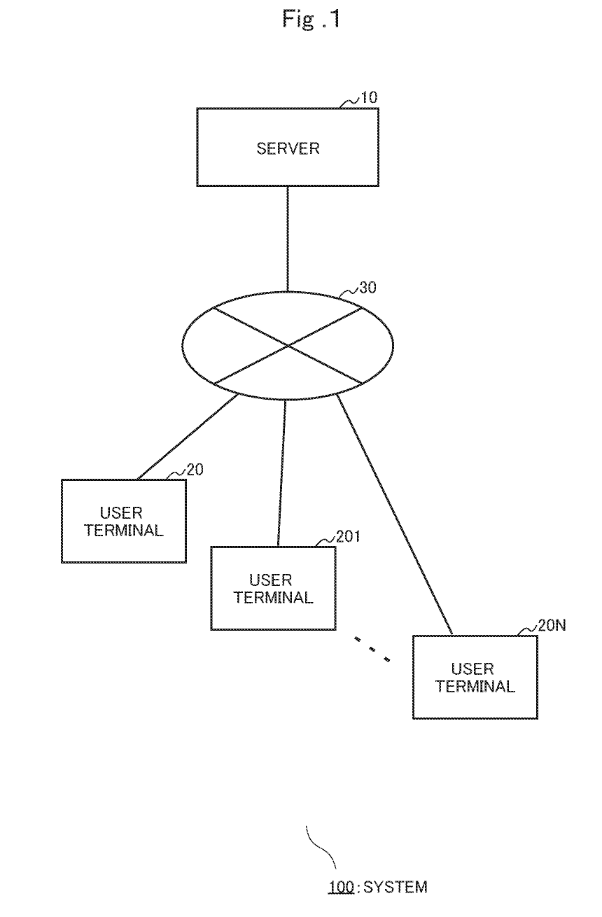

FIG. 1 is a block diagram showing an example of a configuration of a system 100 according to one embodiment of the present invention. As shown in FIG. 1, the system 100 includes a server 10 and a plurality of user terminals 20 and 201 to 20N (“N” is an arbitrary integer), each of which is used by a user of the system. In this regard, a configuration of the system 100 is not limited to this configuration. The video game processing system 100 may be configured so that a plurality of users uses a single user terminal, or may be configured so as to include a plurality of servers.

Each of the server 10 and the plurality of user terminals 20 and 201 to 20N is connected to a communication network 30 such as the Internet. In this regard, although it is not shown in the drawings, the plurality of user terminals 20 and 201 to 20N is connected to the communication network 30 by carrying out data communication with base stations managed by a telecommunication carrier by means of a radio communication line.

The system 100 includes the server 10 and the plurality of user terminals 20, 201 to 20N, whereby various kinds of functions for carrying out various kinds of processes in response to an operation of the user are realized.

The server 10 is managed by an administrator of the system 100, and has various kinds of functions to provide information regarding the various kinds of processes to the plurality of user terminals 20, 201 to 20N. In the present embodiment, the server 10 is constructed by an information processing apparatus, such as a WWW server, and includes a storage medium for storing various kinds of information. In this regard, the server 10 is provided with a general configuration for carrying out the various kinds of processes, such as a control section and a communicating section, as a computer. However, its explanation herein is omitted. Further, in the system 100, it is preferable that the server 10 manages various kinds of information from a point of view to reduce a processing load on each of the plurality of user terminals 20, 201 to 20N. However, the storing section for storing the various kinds of information may include a storage region with a state that the server 10 can access the storage region. For example, the server 10 may be configured so as to be provided with a dedicated storage region outside the server 10.

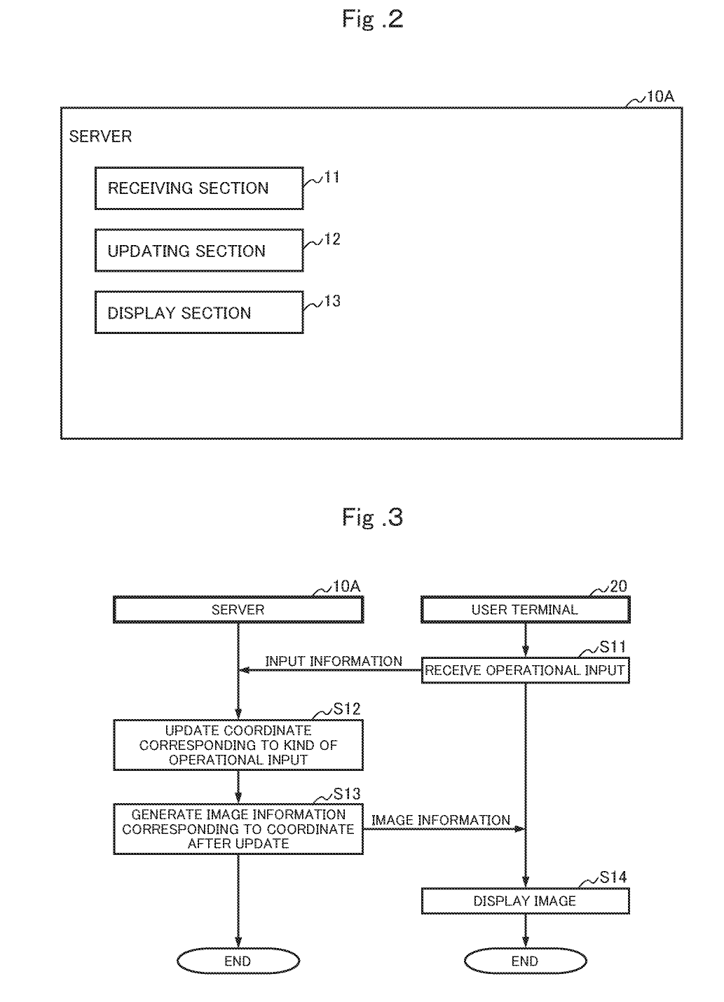

FIG. 2 is a block diagram for showing a configuration of a server 10A that is an example of the configuration of the server 10. As shown in FIG. 2, the server 10A at least includes a receiving section 11, an updating section 12, and a display section 13.

The receiving section 11 has a function to receive a predetermined operational input (hereinafter, referred to as a “first input”) and an operational input other than the first input (hereinafter, referred to as a “second input”) of operational inputs via an operation key or a stick provided on a controller.

Here, the operation key means a portion that the user presses for an input. The number of operation keys provided on the controller is not limited particularly. However, it is preferable that a plurality of operation keys for inputting a plurality of directions by the user are provided. As an example of the operation key, there are four buttons respectively corresponding to four directions.

Further, the stick means a portion that the user tilts for an input. The number of sticks provided on the controller is not limited particularly. However, it is preferable that two or more sticks are provided so as to respectively correspond to right and left hands of the user. As an example of the stick, there is a so-called joystick.

Further, the predetermined operational input means an operational input defined as the first input in advance. The content of the operational input is not limited particularly so long as it corresponds to the controller. However, it is preferable that it is a configuration by which the user can recognize relationship between an operating method and the content of the input.

Further, a difference between the first input and the second input is not limited particularly so long as it can be recognized by the receiving section 11. As examples of the first input and the second input, there are an operational input using a stick provided at a right side of the controller (hereinafter, referred to as a “right stick”) and an operational input using a stick provided at a left side of the controller (hereinafter, referred to as a “left stick”). In this regard, apart of the first input and a part of the second input may be overlapped. Namely, the system 100 may be configured so that, in a case where the first input is a press of the operation key, for example, the second input is a press of the operation key in a state where a predetermined button is pressed.

The updating section 12 has a function to update a coordinate indicating one point in a two-dimensional system (hereinafter, referred to as a “first coordinate”) on the basis of the first input, and update a coordinate different from the first coordinate (hereinafter, referred to as a “second coordinate”) on the basis of the second input.

Here, the configuration of the two-dimensional system is not limited particularly. It may be one corresponding to a display screen of a display device, or one corresponding to a virtual space.

Further, the configuration to update the coordinate on the basis of the first input is not limited particularly. However, it is preferable that the configuration is a configuration in which the user can recognize that one point moves continuously on the basis of an operational input of the user. In this regard, an initial position of the coordinate is not limited particularly. Further, a relationship between the first coordinate and the second coordinate is not limited particularly. However, it is preferable that it is a configuration in which the user can recognize that two coordinates exist. As examples of the two coordinates, there are coordinates in the same coordinate system, and respective coordinates in different coordinate systems.

The display section 13 has a function to display, on the display screen of the display device, at least one of an image corresponding to the first coordinate (hereinafter, referred to as a “first image”) and an image corresponding to the second coordinate (hereinafter, referred to as a “second image”).

Here, a relationship between the coordinate and the image is not limited particularly. However, it is preferable that it is a configuration in which the user can recognize a position of a current coordinate in the two-dimensional system and images corresponding to the respective coordinates.

Further, the method of displaying the first image and the second image is not limited particularly. It may be configured so that two images are displayed on one display screen at the same time, or it may be configured so that one for which a display condition is satisfied is displayed.

Each of the plurality of user terminals 20, 201 to 20N is managed by a user, and is configured by a communication terminal, such as a cellular phone terminal, a PDA (Personal Digital Assistants), and a mobile game device, by which the user can play a network delivery type game, for example. In this regard, a configuration of the user terminal that the system 100 can include is not limited to the examples described above, and may be a configuration in which the user can operate the user terminal via the controller. As other examples of the configuration of the user terminal, there are a personal computer and a game machine.

Further, each of the plurality of user terminals 20, 201 to 20N is connected to the communication network 30, and includes hardware (for example, a display device for displaying a browser screen and a game screen according to a coordinate and the like) and software for carrying out various kinds of processing by communicating with the server 10. In this regard, each of the plurality of user terminals 20, 201 to 20N may be configured so as to be capable of directly communicating with each other without the server 10.

Next, an operation of the system 100 according to the present embodiment will be described.

FIG. 3 is a flowchart showing an example of input/output processing carried out by the system 100. In the input/output processing according to the present embodiment, processing related to an input regarding a coordinate and an output regarding the input is carried out. Hereinafter, the case where the server 10A and a user terminal 20 (hereinafter, referred to as a “terminal 20”) carry out the input/output processing will be described as an example.

The input/output processing is started in a state where specification (or designation) of a coordinate by the controller is allowed, for example. Hereinafter, the case where specification of a coordinate is allowed in the terminal 20 will be described as an example.

In the input/output processing, the terminal 20 first receives an operational input (Step S11). In the present embodiment, the terminal 20 receives the operational input via the controller, and transmits information regarding the received operational input (hereinafter, referred to as “input information”) to the server 10A.

The server 10A updates a coordinate corresponding to a kind of operational input on the basis of the input information received from the terminal 20 (Step S12). In the present embodiment, the server 10A updates the first coordinate in a case where the terminal 20 receives the first input. Further, in a case where the terminal 20 receives the second input, the server 10A updates the second coordinate.

When the coordinate is updated, the server 10A generates information for causing the terminal 20 to display an image corresponding to the coordinate after update (the image information) (Step S13). In the present embodiment, the server 10A generates information for outputting the image according to a kind of the coordinate to the terminal 20, and transmits the generated information to the terminal 20 as the image information. In this regard, a configuration of the image information is not limited particularly. For example, the image information may be information in which the image is compressed, or information for generating the image in the terminal 20. As an example of the information in which the image is compressed, there is one used in a cloud game (for example, MPEG). Further, as the information for generating the image in the terminal 20, there is one used in an online video game (for example, positional information on the object).

The terminal 20 displays an image on the display screen of the display device included therein on the basis of the image information received from the server 10A (Step S14), and terminates the processing herein.

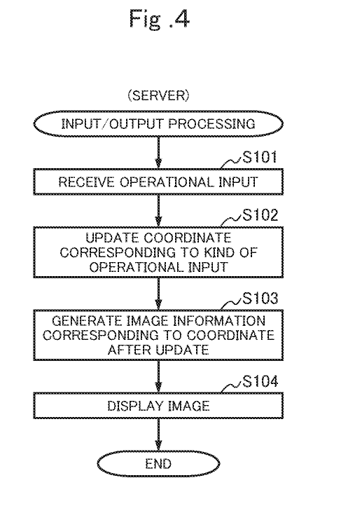

FIG. 4 is a flowchart showing an example of an operation of the server 10A side in the input/output processing. Here, an operation of the server 10A in the system 100 will be described again.

In the input/output processing, the server 10A first receives an operational input (Step S101); updates a coordinate corresponding to a kind of the operational input (Step S102); generates image information corresponding to the coordinate after update (Step S103); and carries out a process to display an image (Step S104). In the present embodiment, the server 10A transmits the image information to the user terminal as the process for displaying the image.

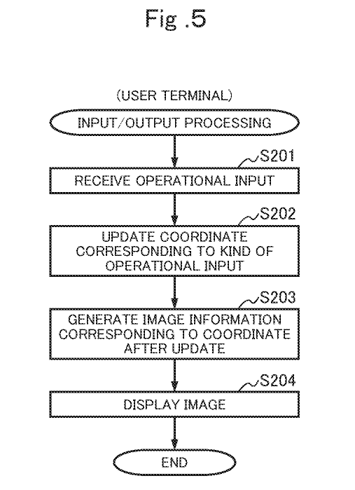

FIG. 5 is a flowchart showing an example of an operation of the terminal 20 side in a case where the terminal 20 carries out the input/output processing. Hereinafter, the case where the terminal 20 carries out the input/output processing by a single body will be described as an example. In this regard, the configuration of the terminal 20 includes the similar functions to the configuration of the server 10 except that various kinds of information are received from the server 10. For this reason, it is omitted from a point of view to avoid repeated explanation.

The terminal 20 receives an operational input via the controller included in the terminal 20 (Step S201). In the present embodiment, the terminal 20 receives an operational input using the left stick included in the controller as the first input, and receives an operational input using the right stick as the second input.

When the operational input is received, the terminal 20 updates the coordinate corresponding to a kind of the received operational input (Step S202), and generates image information corresponding to the coordinate after update (Step S203).

When the image information is generated, the terminal 20 displays an image on the basis of the generated image information (Step S204). In the present embodiment, the terminal 20 displays an image indicating the generated image information in a case where a display condition corresponding to a kind of the coordinate is satisfied.

As explained above, as one side of the first embodiment, the server 10A that includes a function to carry out various kinds of processing on the basis of an operational input via the controller provided with an operation key or stick is configured so as to include the receiving section 11, the updating section 12, and the display section 13. Therefore, the predetermined operational input (the first input) and the operational input different from the first input (the second input) are received, the coordinate indicating one point in the two-dimensional system on the basis of the first input (the first coordinate) is updated, the coordinate different from the first coordinate (the second coordinate) is updated on the basis of the second input, and the display device is caused to display at least one of the image corresponding to the first coordinate (the first image) and the image corresponding to the second coordinate (the second image) on the display screen. This makes it possible to improve operability of a system using the controller that is not provided with a function as a pointing device.

Namely, since plural kinds of coordinates are provided and each of the coordinates can be operated by a different method, it is possible to improve operability compared with conventional one in which one coordinate is operated.

In this regard, the case where the two coordinates can be operated has been explained as an example in the example of the first embodiment described above. However, the server 10A may be configured so that the user is allowed to operate three or more coordinates.

### Second Embodiment

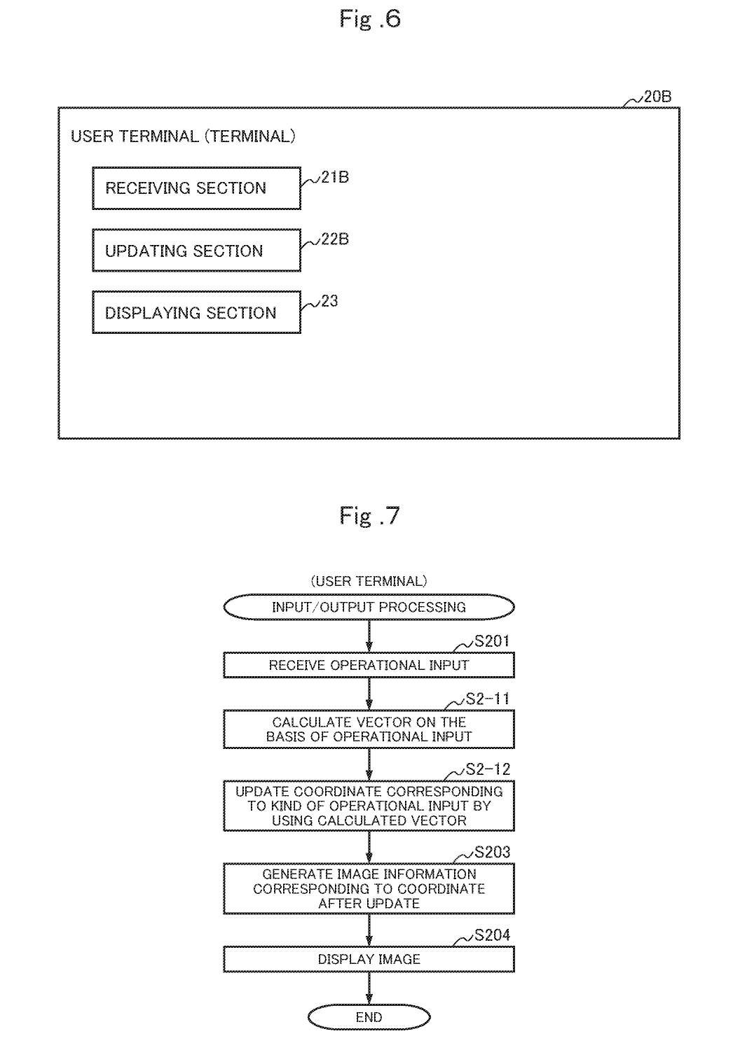

FIG. 6 is a block diagram showing a configuration of a user terminal 20B (hereinafter, referred to as a “terminal 20B”) that is an example of the user terminal 20. In the present embodiment, the terminal 20B at least includes a receiving section 21E, an updating section 22B, and a displaying section 23.

The receiving section 21B has a function to receive operational inputs, in which operability or portions used in a controller are different from each other, as a first input and a second input.

Here, the operability means a property of an operation. Namely, as examples of the operational input whose operability is different from each other, there are an operation to press a button, and an operation to tilt a bar. In this case, for example, in a case where a stick provided on the controller can be pressed and tilted, the user is allowed to input the first input and the second input by using one portion (that is, the stick). On the other hand, an operational input whose operability is the same as each other is included in an operational input in which a portion used in the controller is different from each other. As an example of the operational input in which a portion used in the controller is different from each other, there is, in a case where two sticks are provided on the controller, an operation to tilt each of the two sticks. In this regard, a configuration when the first input and the second input are inputted at the same time is not limited particularly. The configuration may be configured so as to process the respective inputs in parallel, or it may be configured so as to preferentially process one of the inputs in accordance with a priority condition.

The updating section 22B has a function to update a coordinate on the basis of a vector that is calculated on the basis of an input (including the first input and the second input).

Here, the configuration to calculate the vector on the basis of input is not limited particularly. However, it is preferable that it is a configuration in which the user can presume the vector that is calculated by an input of the user. As an example of the configuration to calculate a vector, there is a configuration in which a direction and a size of the vector is calculated from a direction set up for the operation key operated by the user and the number of times to press or a pressing time.

FIG. 7 is a flowchart showing an example of the input/output processing carried out by the terminal 20. Hereinafter, an operation of the terminal 20B will be described as an example. In this regard, description of an operation of the terminal 20B together with the server 10 is omitted from a point of view to avoid repeated explanation.

When an operational input is received, the terminal 20B calculates a vector on the basis of the received operational input (Step S2-11). In the present embodiment, the terminal 20B carries out the calculation of the vector based on the operational input in accordance with a calculation rule corresponding to a kind of the operational input.

When the vector is calculated, the terminal 20B updates the coordinate corresponding to the kind of the operational input by using the calculated vector (Step S2-12), and generates image information corresponding to the coordinate after update. In the present embodiment, the terminal 20B updates the coordinate before update to a coordinate in which the coordinate is moved in a direction indicated by the vector by a size indicated by the vector.

As explained above, as one side of the second embodiment, the user terminal 20B is configured so as to include the updating section 22B. Therefore, it is possible to realize the system that updates the coordinate on the basis of the vector calculated on the basis of the input, and allows an intuitive operation by the user.

Further, as one side of the second embodiment described above, the user terminal 20B is configured so as to include the receiving section 21B. Therefore, it is possible to realize a system in which an operational input to receive, as the first input and the second input, the operational input whose operability is different from each other or for which a portion used in the controller is different from each other, an operational input to update the plurality of coordinates can be carried out relatively easily.

### Third Embodiment

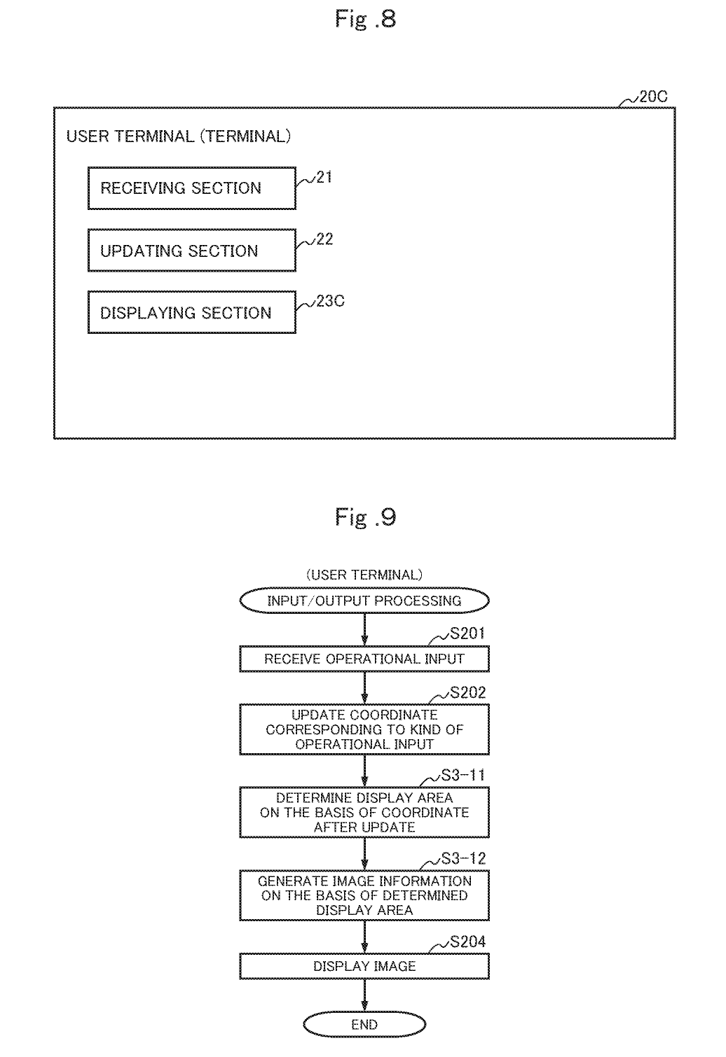

FIG. 8 is a block diagram showing a configuration of a user terminal 20C (hereinafter, referred to as a “terminal 20C”) that is an example of the user terminal 20. In the present embodiment, the terminal 20C at least includes a receiving section 21, an updating section 22, and a displaying section 23C.

The displaying section 23C has a function to determine a display area of a display object on the basis of a coordinate.

Here, the display object means a subject that can be displayed on the display screen. A configuration of the display object is not limited particularly so long as the display area for it can be determined. As examples of the display object, there are a web page, a plain image, and virtual space.

Further, the display area means a scope in which the display object is display on the display screen. A configuration to determine the display area of the display object is not limited particularly so long as it is a configuration based on a coordinate. As an example of the configuration to determine the display area, there is a configuration to define a quadrate scope in which the coordinate is centered.

FIG. 9 is a flowchart showing an example of the input/output processing carried out by the terminal 20. Hereinafter, an operation of the terminal 20C will be described as an example. In this regard, description of an operation of the terminal 20C together with the server 10 is omitted from a point of view to avoid repeated explanation.

When the coordinate is updated on the basis of the received operational input, the terminal 20C determines a display area on the basis of a coordinate after update (Step S3-11). In the present embodiment, the terminal 20C determines a quadrate scope with a predetermined size in which the coordinate after update is centered as the display area with respect to the display object associated with the coordinate.

When the display area is determined, the terminal 20C generates image information on the basis of the determined display area (Step S3-12). In the present embodiment, the terminal 20C generates, as the image information, information for displaying an image including a part or all of the display object corresponding to the display area on the display screen of the display device.

As explained above, as one side of the third embodiment, the user terminal 20C is configured so as to include the displaying section 23C. For that reason, by determining a display area for the subject, which can be displayed on the display screen, on the basis of the coordinate, it is possible to reduce a load of a user required to change a display area by using the controller.

Namely, for example, in a case where the same or different web page is associated with display objects of a first coordinate and a second coordinate, the user of the user terminal 20C is allowed to update a coordinate (that is, change a display area) using an input method having operability matched with a desire of the user of the first input and the second input. Therefore, it is possible to reduce a load of the user compared with a case where there is one inputting method. In this regard, in this case, the user terminal 20C may be configured so as to display the first image and the second image on one display screen.

### Fourth Embodiment

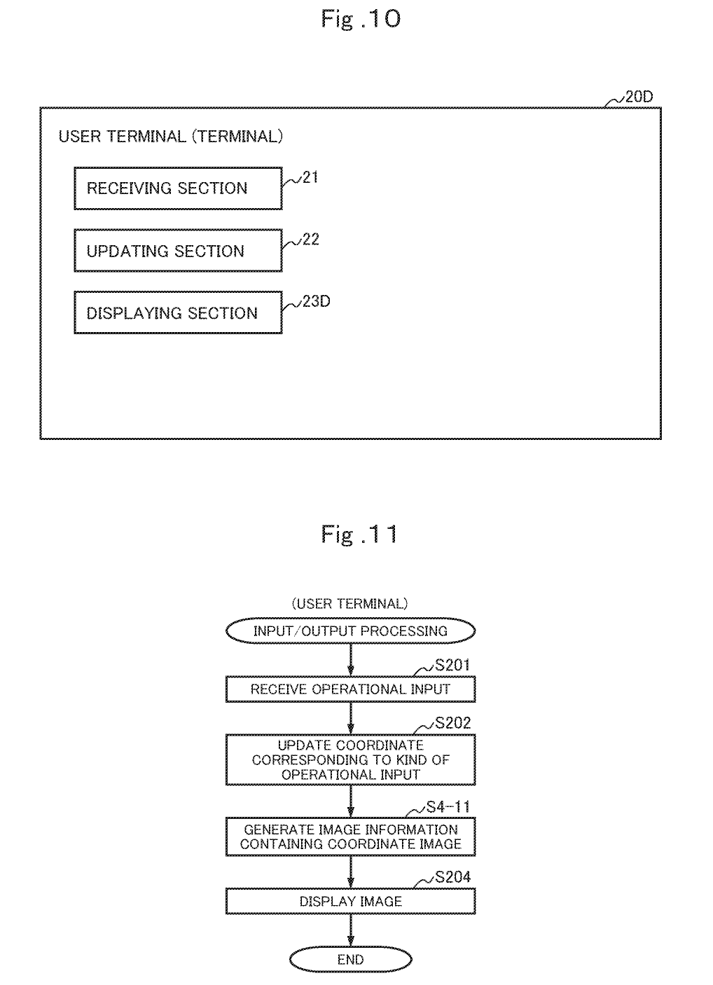

FIG. 10 is a block diagram showing a configuration of a user terminal 20D (hereinafter, referred to as a “terminal 20D”) that is an example of the user terminal 20. In the present embodiment, the terminal 20D at least includes a receiving section 21, an updating section 22, and a displaying section 23D.

The displaying section 23D has a function to display an image for informing a user of a position of a second coordinate (hereinafter, referred to as a “coordinate image”) together with a first image.

Here, a configuration of the image for informing the user of the position of the coordinate is not limited particularly. However, it is preferable that it is a configuration by which the user can recognize movement of the coordinate. As an example of the configuration of the image for informing the user of the position of the coordinate, there is an image in which an image indicating the position of the coordinate (for example, a point) is superimposed on an image corresponding to a two-dimensional system (for example, a map). In this case, by configuring the two-dimensional system corresponding to a first coordinate and the two-dimensional system corresponding to a second coordinate so as to indicate the same plain, and adopting an image indicating a virtual landscape on the plain as the image corresponding to the first coordinate, it is possible to use the coordinate image corresponding to the second coordinate as a so-called mini map.

FIG. 11 is a flowchart showing an example of the input/output processing carried out by the terminal 20. Hereinafter, an operation of the terminal 2 OD will be described as an example. In this regard, description of an operation of the terminal 20D together with the server 10 is omitted from a point of view to avoid repeated explanation.

When the coordinate is updated, the terminal 20D generates image information containing the coordinate image (Step S4-11). In the present embodiment, the terminal 20D generates, as the image information, an image for displaying an image containing an image corresponding to the first coordinate (the first image) and the coordinate image corresponding to the second coordinate.

As explained above, as one side of the fourth embodiment, the user terminal 20D is configured so as to include the displaying section 23D. For that reason, the image for informing the user of the position of the second coordinate (the coordinate image) is displayed together with the first image. This makes it possible to improve convenience of the system in which plural kinds of coordinate positions are used.

Namely, by configuring the system 100 so that, even in a case where only the image corresponding to one coordinate of the two coordinates is displayed, the user can recognize the other coordinate, it is possible to provide, to the user, an environment in which the other coordinate is operated easily compared with a configuration in which the user cannot recognize the other coordinate.

In this regard, it has not been mentioned particularly in the example of the fourth embodiment described above. However, the user terminal 20D may be configured so as to display the image for informing the user of the position of the first coordinate together with the second image, or may be configured so as to display the coordinate image by a single body.

### Fifth Embodiment

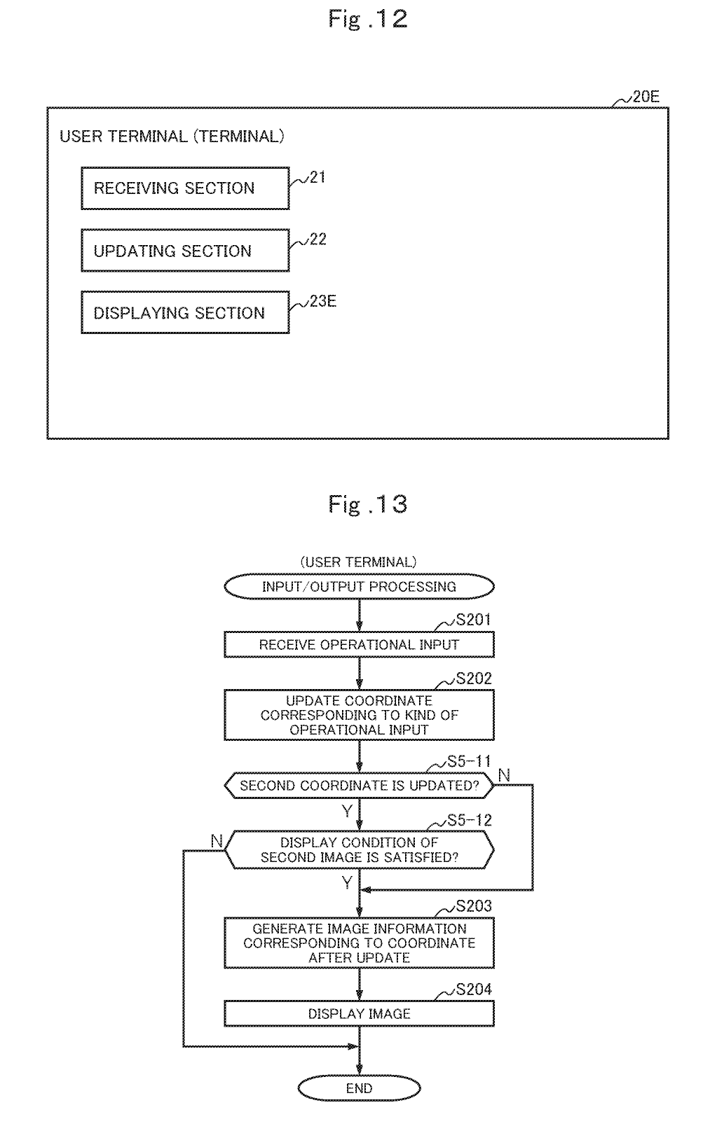

FIG. 12 is a block diagram showing a configuration of a user terminal 20E (hereinafter, referred to as a “terminal 20E”) that is an example of the user terminal 20. In the present embodiment, the terminal 20E at least includes a receiving section 21, an updating section 22, and a displaying section 23E.

In the present embodiment, each of a first coordinate and a second coordinate is a coordinate for specifying a point of view in the same virtual space. Namely, the system 100 is configured so that a plurality of coordinates in one virtual space is managed and each of the coordinates is allowed to move on the basis of an operational input via a controller.

In this regard, a configuration regarding a movement speed of each of the first coordinate and the second coordinate is not limited particularly. For example, it may be configured so that the movement speed of each of the coordinates is different from each other. Namely, the system 100 may be configured so that with respect to the first coordinate and the second coordinate that are coordinates of a two-dimensional system corresponding to one plain in the virtual, a movement speed of the first coordinate by a first operation is different from a movement speed of the second coordinate by a second operation. In this case, a relationship between the movement speeds of the respective coordinates is not limited particularly. For example, it may be configured so that a speed according to a size of the displayed image (that is, a position of a virtual camera with respect to a focus point or a magnification ratio of the virtual camera) is set up.

The displaying section 23E has a function to display an image (hereinafter, referred to as a “second image”) indicating the virtual space corresponding to the second coordinate in a case where a predetermined condition is satisfied when an image indicating the virtual space corresponding to the first coordinate (hereinafter, referred to as a “first image”) is displayed.

Here, the content of the predetermined condition is not limited particularly, and it may be a time when there is a request from the user. Further, it may be configured so that a display of the first image is terminated when the second image is displayed, or so that both the first image and the second image are displayed.

FIG. 13 is a flowchart showing an example of input/output processing carried out by the terminal 20. Hereinafter, an operation of the terminal 20E will be described as an example. In this regard, description of an operation of the terminal 20E together with the server 10 is omitted from a point of view to avoid repeated explanation.

When the coordinate corresponding to the kind of the received operational input is updated, the terminal 20E determines whether the second coordinate is updated or not (Step S5-11). Here, in a case where it is determined that the second coordinate is not updated because the first coordinate is updated (“No” at Step S5-11), the terminal 20E generates image information corresponding to a coordinate after update.

On the other hand, in a case where it is determined that the second coordinate is updated (“Yes” at Step S5-11), the terminal 20E determines whether a display condition of the second image is satisfied or not (Step S5-12). Here, in a case where it is determined that the display condition is not satisfied (“No” at Step S5-12), the terminal 20 terminates the processing herein. On the other hand, in a case where it is determined that the display condition is satisfied (“Yes” at Step S5-12), the terminal 20 generates image information corresponding to a coordinate after update.

As explained above, as one side of the fifth embodiment, the user terminal 20E is configured so as to include the displaying section 23E and so that each of the first coordinate and the second coordinate is a coordinate for specifying a point of view in the same virtual space. Therefore, the image indicating the virtual space corresponding to the second coordinate is displayed in a case where the predetermined condition is satisfied when the image indicating the virtual space corresponding to the first coordinate is displayed. This makes it possible to reduce a load on a coordinate operation by means of the controller that does not include a function as the pointing device.

Namely, since the image can be caused to be displayed by operating a plurality of coordinates, it is possible to improve the degree of freedom regarding the coordinate operation compared with the case of operating one point. For that reason, for example, in a case where the system 100 according to the fifth embodiment is used in the video game, it is possible to set up a current position of a player as the first coordinate, and to set up a position where the player (or a player character) can warp as the second coordinate. Further, in a video game using FPS, it is possible to confirm a target object by temporarily zooming by means of a camera, and it is possible to return to the original in a released moment. Further, so long as the video game is a tower defense type game, it is possible to confirm an attack point of an enemy or a cooperator and to return by temporarily moving the camera. Further, it is possible to glance around and return even in a case where the video game is a field searching game. Furthermore, it may be configured so that, in a case where an object indicating a warp available point (the second coordinate) is displayed within a screen (the camera) (within the first image), the object warps to the point. Further, in a case where a genre of the video game is an RTS, it is possible to realize, by means of the controller (for example, a game pad) operation, a system in which it is possible to operate a point of the virtual camera (the second coordinate) separately while maintaining (and movable) its original coordinate (the first coordinate), and the player is caused to warp there. In this regard, it may be configured so that a map moving mode is explicitly provided and it is set to an operation mode for the controller.

In this regard, it has not been mentioned particularly in the example of the fifth embodiment described above. However, the user terminal 20E may be configured so as to store the second coordinate as a camera coordinate for a return value. In this case, the user terminal 20E may be configured so that a coordinate when to start to move the coordinate is stored in still another manner. By configuring the user terminal 20E in this manner, it becomes possible to reset the coordinate whose movement is started by carrying out another operation by the user in the middle of movement in a case where it is configured so that the user arbitrarily moves the camera coordinate for the return value, for example.

Further, it has not been mentioned particularly in the example of the fifth embodiment described above. However, the user terminal 20E may be configured to control the display screen so that the virtual camera is warped to a final specification point at the time when an operation to move the second coordinate (for example, at the time of releasing a button).

### Sixth Embodiment

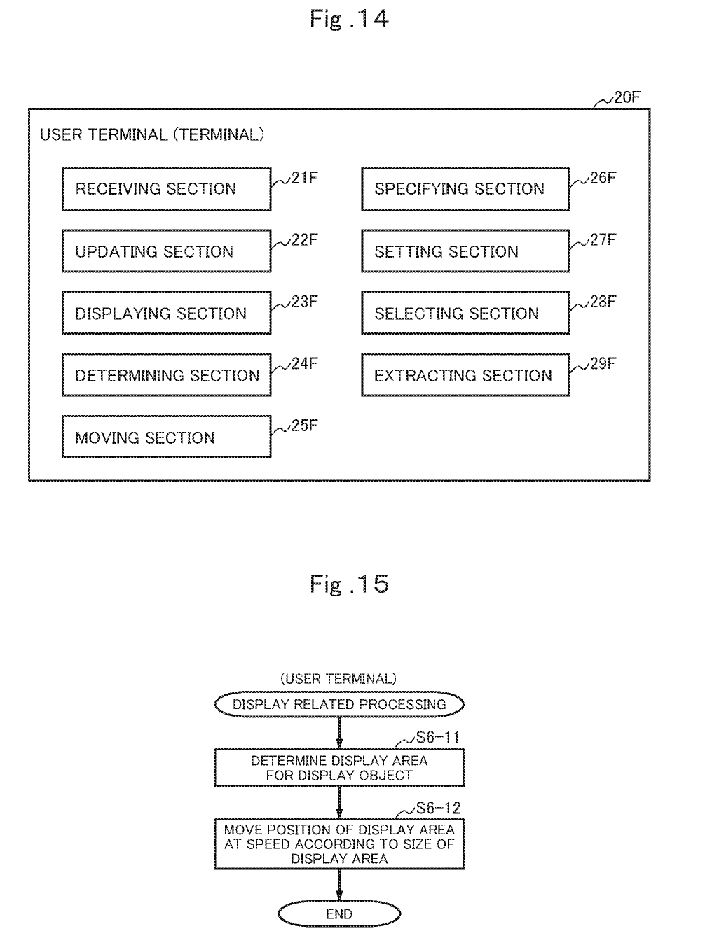

FIG. 14 is a block diagram showing a configuration of a user terminal 20F (hereinafter, referred to as a “terminal 20F”), which is an example of the user terminal 20 in the system 100 (see FIG. 1). Hereinafter, the case where progress of a video game (here, a so-called network game), which proceed while communicating with a server 10 appropriately, is controlled in the terminal 20F provided with a display device will be described as an example.

In the present embodiment, the terminal 20F at least includes a receiving section 21F, an updating section 22F, a displaying section 23F, a determining section 24F, a moving section 25F, a specifying section 26F, a setting section 27F, a selecting section 28F, and an extracting section 29F.

The receiving section 21F has a function to receive a predetermined operational input (hereinafter, referred to as a “first input”) and an operational input other than the first input (hereinafter, referred to as a “second input”). In the present embodiment, the receiving section 21F receives a pressing operation of a directional key provided in a controller (in particular, a so-called game pad) as the first input, and receives an operation in which a stick provided in the same controller is tilted as the second input.

The updating section 22F has a function to update a coordinate indicating one point in a two-dimensional system on the basis of the first input (hereinafter, referred to as a “first coordinate”), and to update a coordinate different from the first coordinate (hereinafter, referred to as a “second coordinate”) on the basis of the second input. In the present embodiment, the updating section 22F manages a coordinate indicating a position of a virtual camera for photographing a virtual space as the first coordinate, and a coordinate indicating one point in a two-dimensional map indicating the virtual space (hereinafter, referred to as a “mini map”) as the second coordinate. In this regard, a configuration of the mini map is not limited particularly. However, it is preferable that it is a configuration in which a status of a facility or an object arranged in the virtual space is indicated.

The displaying section 23F has a function to cause a display device to display, on a display screen, at least one of an image corresponding to the first coordinate (hereinafter, referred to as a “first image”) and an image corresponding to the second coordinate (hereinafter, referred to as a “second image”). In the present embodiment, the displaying section 23F displays, as the first image, an image obtained by photographing a battle field in which a battle is carried out as the video game, from the first coordinate (i.e., a field image). Further, in the present embodiment, the displaying section 23F displays, as the second image, an image obtained by photographing the battle field from the second coordinate when a predetermined condition is satisfied. In this regard, a position of the second coordinate according to the present embodiment is informed to the user by means of the mini map displayed on the display screen.

The determining section 24F has a function to determine a size of a display area for a subject that can be displayed on the display screen (hereinafter, referred to as a “display object”). In the present embodiment, the determining section 24F determines the battle field as the display object and the size of the display area by zoom in and zoom out of the virtual camera. Namely, the determining section 24F determines the size of the display area on the basis of information regarding the virtual camera (containing a position, a focus point, an angle of view and the like).

The moving section 25F has a function to cause a position of the display area for the display object to move at a speed according to the size of the display area on the basis of a predetermined operational input. Namely, in the present embodiment, the moving section 25F changes a movement speed on the basis of approach or going away of the virtual camera.

The specifying section 26F has a function to specify a coordinate indicating one point in the virtual space in which the object is arranged (hereinafter, referred to as a “selection standard coordinate”) on the basis of a predetermined operational input. Here, the selection standard coordinate may be one indicating one point of the two-dimensional system, or one indicating one point of a three-dimensional or more coordinate system. In the present embodiment, the specifying section 26F specifies the selection standard coordinate that moves on the virtual space by an operation different from the operation regarding the virtual camera. In this regard, it may be configured so that the selection standard coordinate is moved by the same operation as the operation regarding the virtual camera (that is, on the basis of the position of the virtual camera).

The setting section 27F has a function to set up an object positioned at an area defined on the basis of the coordinate specified by the specifying function to a selection state. In the present embodiment, the setting section 27F sets up the object positioned within the area with a predetermined shape defined so that the selection standard coordinate is centered to the selection state. In this regard, it may be configured so that the object selected at this time is limited to the object of the user (user object), or so that it is limited to an object of the enemy (enemy object).

The selecting section 28F has a function to cause the user to select an object from a plurality of objects. Here, a configuration to cause the user to select an object is not limited particularly. It may be configured so as to allow a direct selection for the object, or may be configured so as to allow an indirect selection (for example, selection from a list). In the present embodiment, the selecting section 28F causes the user to select an object from a plurality of objects by allowing the user to carry out a selection operation for the image indicating a list of the user objects summoned in the battle field.

The extracting section 29F has a function to extract, as an operational subject of the user, other object for which a predetermined condition is satisfied on the basis of the position of the object selected by the user. Here, the content of the predetermined condition is not limited particularly. For example, it may be configured so that the user is allowed to determine a condition. Further, it may be configured so that other object for which the condition selected by the user is satisfied is extracted as the operational subject of the user among a plurality of conditions (hereinafter, referred to as “extraction conditions”). In this case, it may be configured so that the extraction condition is determined on the basis of the information regarding the object selected by the user. As examples of the information regarding the object, there are a kind and/or a property of the object, and a position and/or a peripheral situation in the virtual space (presence or absence of other object, and the like). In this regard, the extraction herein means selection of ones of a predetermined number from plural ones, and the extracted object is set up to a selection state. Further, one that carries out an action according to an operational input, and one that becomes a subject of an action are included in the operational subject herein.

FIG. 15 is a flowchart showing an example of processing related to display carried out by the terminal 20 (hereinafter, referred to as “display related processing”). Hereinafter, an operation of the terminal 20F will be described as an example. In this regard, description of an operation of the terminal 20F together with the server 10 is omitted from a point of view to avoid repeated explanation.

In the display related processing, the terminal 20F first determines a display area for a display object (Step S6-11). In the present embodiment, the terminal 20F determines the display object and the display area for the display object in order to display a game screen according to progress of the video game.

When the display area is determined, the terminal 20F causes a position of the display area to move at a speed according to a size of the display area (Step S6-12). In the present embodiment, the terminal 20F moves, when a movement operation for the display area by the user is received, the position of the display area at a faster speed compared with the case the display area is smaller as a current display area becomes larger. Namely, in the present embodiment, a change rate of the coordinate with respect to the same operation becomes higher as the display area becomes wider.

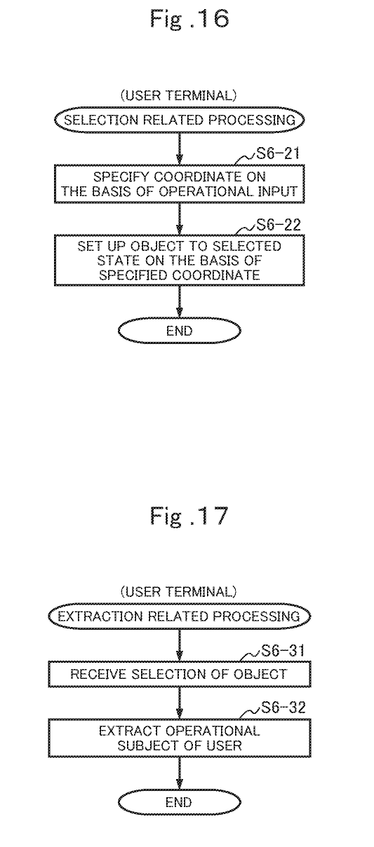

FIG. 16 is a flowchart showing an example of a process related to selection carried out by the terminal 20 (hereinafter, referred to as “selection related processing”). Hereinafter, an operation of the terminal 20F will be described as an example. In this regard, description of an operation of the terminal 20F together with the server 10 is omitted from a point of view to avoid repeated explanation.

In the selection related processing, the terminal 20F first specifies a coordinate on the basis of an operational input by the user (Step S6-21). In the present embodiment, the terminal 20F specifies a coordinate indicating one point in the virtual space as the selection standard coordinate.

When the coordinate is specified, the terminal 20F sets the object to a selection state on the basis of the specified coordinate (Step S6-22). In the present embodiment, the terminal 20F sets up an object positioned within a circular area in which the selection standard coordinate is defined as a center to a selection state. Further, in the present embodiment, a shape or a position of the circular area can be changed until the selection operation is terminated.

FIG. 17 is a flowchart showing an example of processing regarding extraction carried out by the terminal 20 (extraction related processing). Hereinafter, an operation of the terminal 20F will be described as an example. In this regard, an operation of the terminal 20 with the server 10 is omitted from a point of view to avoid repeated explanation.

In the selection related processing, the terminal 20F first receives selection of an object by the user (Step S6-31). In the present embodiment, the terminal 20F receives a selection operation for a party list for which a group of objects of the user (that is, a user's team) and a group of objects of an enemy (that is, an enemy team) can be switched and displayed.

When the selection of the object is received, the terminal 20F extracts the operational subject of the user on the basis of the position of the selected object (Step S6-32). In the present embodiment, the terminal 20F presents, to the user, a kind of other object that is positioned around the selected object, receives a kind selection by the user, and extracts an object with the received kind as the operational subject of the user.

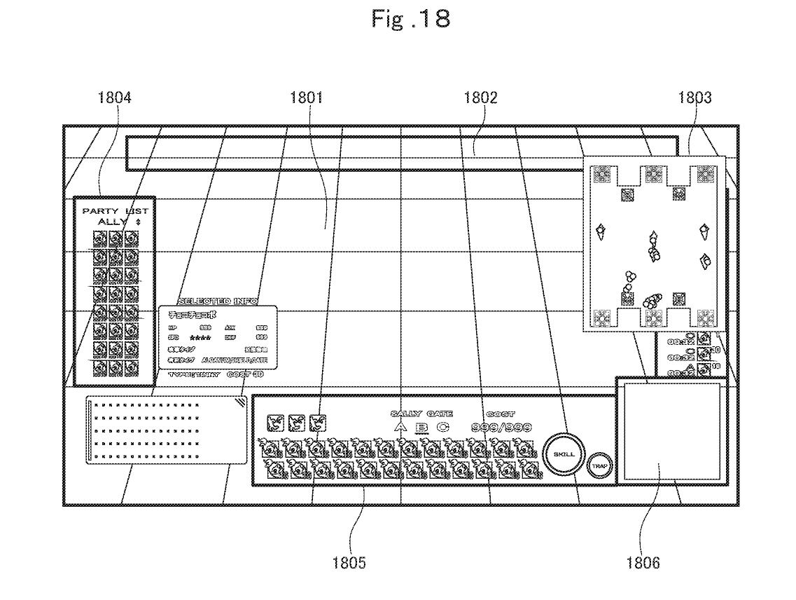

FIG. 18 is an explanatory drawing for explaining an example of the game screen. As shown in FIG. 18, a display area 1801 of an image indicating a battle field, a display area 1802 in which information regarding a battle status is displayed, a display area 1803 for the mini map, a display area 1804 for a list indicating an object arranged in the battle field, a display area 1805 for a UI used when the user summons the object into the battle field, and a display area 1806 for the object that is in a waiting state until the object is summoned are provided in the game screen.

As explained above, as one side of the sixth embodiment, the computer (the user terminal 20F), which carries out various kinds of processing on the basis of an operational input via the controller, is configured so as to include the determining section 24F and the moving section 25F. Therefore, the size of the display area with respect to the subject that can be displayed on the display screen (display object) is determined, and the position of the display area with respect to the display object is caused to move at the speed according to the size of the display area on the basis of the predetermined operational input. This makes it possible to provide, to the user, a system in which the movement speed can be changed on the basis of approach or going away of the virtual camera.

Further, as one side of the sixth embodiment described above, the computer (the user terminal 20F), which carries out various kinds of processing on the basis of an operational input via the controller provided with an operation key or stick, is configured so as to include the specifying section 26F and the setting section 27F. Therefore, the coordinate indicating one point in the virtual space in which the object is arranged is specified on the basis of the predetermined operational input, and an object that is positioned in the area defined on the basis of the specified coordinate is set up to the selection state. This makes it possible to improve operability when the object is selected by a coordinate operation using the controller.

Further, as one side of the sixth embodiment described above, the computer (the user terminal 20F) that carries out the various kinds of processing on the basis of the operational input via the controller including the operation key or the stick is configured so as to include the selecting section 28F and the extracting section 29F. Therefore, the user is caused to select an object from the plurality of objects, and other object for which the predetermined condition is satisfied with respect to the position of the object selected by the user is extracted as the operational subject of the user. This makes it possible to improve operability when an object is selected by using the controller.

Further, as one side of the sixth embodiment described above, the user terminal 20F is configured so as to include the extracting section 29F. Therefore, other object that is positioned around the object selected by the user is presented to the user in such a form that the user can recognize a kind of each of the objects, and an object with the kind selected by the user is extracted as the operational subject of the user. This makes it possible to improve operability further when the object is selected by using the controller.

As explained above, one or two or more shortages can be solved by each of the embodiments according to the present application. In this regard, the effects by each of the embodiments are non-limiting effects or one example of the non-limiting effects.

In this regard, in each of the embodiments described above, each of the plurality of user terminals 20, 201 to 20N and the server 10 carries out the various kinds of processing described above in accordance with various kinds of control programs (for example, a video game processing program) stored in the storage device with which the corresponding terminal or server is provided.

Further, the configuration of the system 100 is not limited to the configuration that has been explained as an example of each of the embodiments described above. For example, the system 100 may be configured so that the server 10 carries out a part or all of the processes that have been explained as the processes carried out by the user terminal. Alternatively, the system 100 may be configured so that any of the plurality of user terminals 20, 201 to 20N (for example, the user terminal 20) carries out apart or all of the processes that have been explained as the processes carried out by the server 10. Further, the system 100 may be configured so that a part or all of the storing sections included in the server 10 is included in any of the plurality of user terminals 20, 201 to 20N. Namely, the system 100 may be configured so that a part or all of the functions of any one of the user terminal 20 and the server 10 according to the system 100 is included in the other.

Further, the program product may be configured so as to cause a single apparatus that does not include a communication network to realize a part or all of the functions that have been explained as the examples of the respective embodiments described above.

In this regard, the word “in accordance with progress of the video game” means that occurrence of various kinds of progress or changes and the like that can be generated in the video game becomes timing or a standard of a specific process. As examples of the specific process, there are a determining process, an information updating process, and the like. Further, as examples of the various kinds of progress or changes that can be generated in the video game, there are progress of time, a change in a game element value, a specific status or update of a flag, an operation input by the user, and the like.

(Appendix)

The explanation of the embodiments described above has been described so that the following inventions can be at least realized by a person having a normal skill in the art to which the present invention belongs.

(1)

A non-transitory computer-readable medium including a program product for causing a computer to realize functions to carry out various kinds of processing on the basis of an operational input via an operation key or a stick provided in a controller,

wherein the functions include:

a receiving function configured to receive a predetermined operational input (hereinafter, referred to as a “first input”) and an operational input different from the first input (hereinafter, referred to as a “second input”) of operational inputs;

an updating function configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and

a displaying function configured to display, on a display screen of a display device, at least one of an image corresponding to the first coordinate (hereinafter, referred to as a “first image”) and an image corresponding to the second coordinate (hereinafter, referred to as a “second image”).

(2)

The non-transitory computer-readable medium according to claim (1),

wherein the updating function includes a function configured to update the coordinate on the basis of a vector, the vector being calculated on the basis of the input.

(3)

The non-transitory computer-readable medium according to claim (1) or (2),

wherein the receiving function includes a function configured to receive operational inputs for each of which operability or a portion used in the controller is different from each other as the first input and the second input.

(4)

The non-transitory computer-readable medium according to any one of claims (1) to (3),

wherein the displaying function includes a function configured to determine a display area of a subject on the basis of the coordinate, the subject being able to displayed on the display screen.

(5)

The non-transitory computer-readable medium according to any one of claims (1) to (4),

wherein the displaying function includes a function configured to display an image for informing the user of a position of the second coordinate (hereinafter, referred to as a “coordinate image”) together with the first image.

(6)

The non-transitory computer-readable medium according to any one of claims (1) to (5),

wherein each of the first coordinate and the second coordinate is a coordinate for specifying a point of view in the same virtual space, and

wherein the displaying function includes a function configured to display an image indicating a virtual space corresponding to the second coordinate in a case where a predetermined condition is satisfied when an image indicating a virtual space corresponding to the first coordinate is displayed.

(7)

A non-transitory computer-readable medium including a program product for causing a server to realize at least one function of the functions that the computer is caused to realize in accordance with the non-transitory computer-readable medium according to any one of claims (1) to (6), the server being allowed to communicate with the computer.

(8)

A computer in which the program product described in any one of claims (1) to (10) is installed.

(9)

A system including a communication network, a server, and a user terminal, the user terminal carrying out various kinds of processing on the basis of an operational input via an operation key or a stick provided in a controller, the system comprising:

a receiving section configured to receive a predetermined operational input (hereinafter, referred to as a “first input”) and an operational input different from the first input (hereinafter, referred to as a “second input”) of operational inputs;

an updating section configured to update a coordinate indicating one point in a two-dimensional system (hereinafter, referred to as a “first coordinate”) on the basis of the first input, the updating section being configured to update a coordinate different from the first coordinate (hereinafter, referred to as a “second coordinate”) on the basis of the second input; and

a displaying section configured to cause a display device to display, on a display screen, at least one of an image corresponding to the first coordinate (hereinafter, referred to as a “first image”) and an image corresponding to the second coordinate (hereinafter, referred to as a “second image”).

(10)

The system according to claim (9),

wherein the server includes the receiving section, the updating section, and the displaying section, and

wherein the computer includes a function configured to receive information for displaying the first image and the second image from the server.

(11)

A non-transitory computer-readable medium including a program product for causing a server to realize functions to carry out various kinds of processing on the basis of an operational input via an operation key or a stick provided in a controller,

wherein the functions include:

a receiving function configured to receive a predetermined operational input (hereinafter, referred to as a “first input”) and an operational input different from the first input (hereinafter, referred to as a “second input”) of operational inputs;

an updating function configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and

a displaying function configured to display, on a display screen of a display device, at least one of an image corresponding to the first coordinate (hereinafter, referred to as a “first image”) and an image corresponding to the second coordinate (hereinafter, referred to as a “second image”).

(12)

A non-transitory computer-readable medium including a program product for causing a user terminal to realize functions to carry out various kinds of processing on the basis of an operational input via an operation key or a stick provided in a controller,

wherein a server includes:

a receiving function configured to receive a predetermined operational input (hereinafter, referred to as a “first input”) and an operational input different from the first input (hereinafter, referred to as a “second input”) of operational inputs;

an updating function configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and

a displaying function configured to display, on a display screen of a display device, at least one of an image corresponding to the first coordinate (hereinafter, referred to as a “first image”) and an image corresponding to the second coordinate (hereinafter, referred to as a “second image”), and

wherein the functions includes:

a receiving function configured to receive, from the server, information for displaying the first image and the second image.

(13)

A non-transitory computer-readable medium including a program product for causing a user terminal to realize at least one function of the functions that the program product described in claim 11) causes the server to realize, the user terminal being capable of communicating with the server.

(14)

A server in which the program product described in claim (11) is installed.

(15)

A method of carrying out various kinds of processing on the basis of an operational input via an operation key or a stick provided in a controller, the method comprising:

a receiving process configured to receive a predetermined operational input (hereinafter, referred to as a “first input”) and an operational input different from the first input (hereinafter, referred to as a “second input”) of operational inputs;

an updating process configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and

a displaying process configured to display, on a display screen of a display device, at least one of an image corresponding to the first coordinate (hereinafter, referred to as a “first image”) and an image corresponding to the second coordinate (hereinafter, referred to as a “second image”).

(16)

A method of carried out by a system for carrying out various kinds of processing on the basis of an operational input via an operation key or a stick provided in a controller, the system including a communication network, a server, and a user terminal, the method comprising:

a receiving process configured to receive a predetermined operational input (hereinafter, referred to as a “first input”) and an operational input different from the first input (hereinafter, referred to as a “second input”) of operational inputs;

an updating process configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and

a displaying process configured to display, on a display screen of a display device, at least one of an image corresponding to the first coordinate (hereinafter, referred to as a “first image”) and an image corresponding to the second coordinate (hereinafter, referred to as a “second image”).

(100)

A non-transitory computer-readable medium including a program product for causing a computer to realize functions to carry out various kinds of processing on the basis of an operational input via a controller,

wherein the functions include:

a determining function configured to determine a size of a display area to a subject that is allowed to be displayed on a display screen (hereinafter, referred to as a “display object”); and

a moving function configured to cause a position of the display area to the display object to move at a speed according to the size of the display area on the basis of a predetermined operational input.

(200)

A non-transitory computer-readable medium including a program product for causing a computer to realize functions to carry out various kinds of processing on the basis of an operational input via a controller, the controller including an operation key or a stick, wherein the functions include:

a specifying function configured to specify a coordinate indicating one point in a virtual space on the basis of a predetermined operational input, an object being arranged in the virtual space; and

a setting function configured to set up the object positioned at an area to a selection state, the area being defined on the basis of the coordinate specified by the specifying function.

(300)

A non-transitory computer-readable medium including a program product for causing a computer to realize functions to carry out various kinds of processing on the basis of an operational input via a controller, the controller including an operation key or a stick,

wherein the functions include:

a selecting function configured to cause a user to select an object from a plurality of objects; and

an extracting function configured to extract other object as an operational subject of the user, the other object satisfying a predetermined condition with respect to a position of the object selected by the user.

(301)

The non-transitory computer-readable medium according to claim (300),

wherein the extracting function includes a function configured to present other object positioned around the object selected by the user to the user in such a form that the user is allowed to recognize a kind of each of objects, and to extract an object of the kind selected by the user as the operational subject of the user.

According to one of the embodiments of the present invention, it is useful to improve operability of a system in which a controller that does not include a function as a pointing device is used.

What is claimed is:

1. A non-transitory computer-readable medium including a program product for causing a computer to realize functions to carry out various kinds of processing on the basis of an operational input via an operation key or a stick provided in a controller,
wherein the functions include:
a receiving function configured to receive a predetermined operational input (hereinafter, referred to as a “first input”) and an operational input different from the first input (hereinafter, referred to as a “second input”) of operational inputs;
an updating function configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and
a displaying function configured to display, on a display screen of a display device, at least one of an image corresponding to the first coordinate (hereinafter, referred to as a “first image”) and an image corresponding to the second coordinate (hereinafter, referred to as a “second image”).

2. The non-transitory computer-readable medium according to claim 1,
wherein the updating function includes a function configured to update the coordinate on the basis of a vector, the vector being calculated on the basis of the input.

3. The non-transitory computer-readable medium according to claim 1,
wherein the receiving function includes a function configured to receive operational inputs for each of which operability or a portion used in the controller is different from each other as the first input and the second input.

4. The non-transitory computer-readable medium according to claim 1,
wherein the displaying function includes a function configured to determine a display area of a subject on the basis of the coordinate, the subject being able to be displayed on the display screen.

5. The non-transitory computer-readable medium according to claim 1,
wherein the displaying function includes a function configured to display an image for informing the user of a position of the second coordinate (hereinafter, referred to as a “coordinate image”) together with the first image.

6. The non-transitory computer-readable medium according to claim 1,
wherein each of the first coordinate and the second coordinate is a coordinate for specifying a point of view in the same virtual space, and
wherein the displaying function includes a function configured to display an image indicating a virtual space corresponding to the second coordinate in a case where a predetermined condition is satisfied when an image indicating a virtual space corresponding to the first coordinate is displayed.

7. A system including a communication network, a server, and a user terminal, the user terminal carrying out various kinds of processing on the basis of an operational input via an operation key or a stick provided in a controller, the system comprising:
a receiving section configured to receive a predetermined operational input (hereinafter, referred to as a “first input”) and an operational input different from the first input (hereinafter, referred to as a “second input”) of operational inputs;
an updating section configured to update a coordinate indicating one point in a two-dimensional system (hereinafter, referred to as a “first coordinate”) on the basis of the first input, the updating section being configured to update a coordinate different from the first coordinate (hereinafter, referred to as a “second coordinate”) on the basis of the second input; and
a displaying section configured to cause a display device to display, on a display screen, at least one of an image corresponding to the first coordinate (hereinafter, referred to as a “first image”) and an image corresponding to the second coordinate (hereinafter, referred to as a “second image”).

8. A method of carrying out various kinds of processing on the basis of an operational input via an operation key or a stick provided in a controller, the method comprising:
a receiving process configured to receive a predetermined operational input (hereinafter, referred to as a “first input”) and an operational input different from the first input (hereinafter, referred to as a “second input”) of operational inputs;
an updating process configured to update a coordinate indicating one point in a two-dimensional system on the basis of the first input (hereinafter, referred to as a “first coordinate”), the updating function being configured to update a coordinate different from the first coordinate (hereinafter, referred to as a “second coordinate”) on the basis of the second input; and
a displaying process configured to display, on a display screen of a display device, at least one of an image corresponding to the first coordinate (hereinafter, referred to as a “first image”) and an image corresponding to the second coordinate (hereinafter, referred to as a “second image”).
